(19) United States
(12) Patent Application Publication
(10) Pub. No.: US 2020/0050971 A1
(43) Pub. Date: Feb. 13, 2020

(54) Minibatch Parallel Machine Learning System Design

(71) Applicant: International Business Machines Corporation, Armonk, NY (US)

(72) Inventors: Changhoan Kim, Ossining, NY (US); Michael P. Perrone, Yorktown Heights, NY (US)

(21) Appl. No.: 16/058,017

(22) Filed: Aug. 8, 2018

(51) Int. Cl. G06N 99/00

(52) U.S. Cl. CPC G06N 99/005

(57) ABSTRACT

The disclosure is directed to optimizing parallel machine learning system design and performance using minibatch. A system for allocating data center resources according to embodiments includes: a machine learning process; a machine learning data set; a processing system including a P parallel processing elements for training the machine learning process using the machine learning data set, wherein the machine learning data set is split into a plurality of batches with a batch size M; and a resource manager for (1) minimizing a training time T=T(M,P) of the machine learning process over M for each value of P, and (2) efficient system design.

### TECHNICAL FIELD

The present invention relates generally to machine learning, and more particularly, to a method, system, and computer program product for optimizing parallel machine learning system design and performance using minibatch.

### BACKGROUND

Machine learning is a field of computer science that gives computer systems the ability to “learn” (i.e., progressively improve performance on a specific task) with data without being explicitly programmed.

Optimization algorithms, such as gradient descent, are often used for finding the weights or coefficients of machine learning algorithms, such as artificial neural networks and logistic regression. Gradient descent works by having the model make predictions on training data and use the error on the predictions to update the model in such a way as to reduce the error. The goal of the algorithm is to find model parameters (e.g. coefficients or weights) that minimize the error of the model on the training dataset. It does this by making changes to the model that move it along a gradient or slope of errors toward a minimum error value.

Stochastic gradient descent (SGD) is a variation of the gradient descent algorithm that splits the training dataset into small batches (minibatches) that are used to calculate model error and update model coefficients. Small minibatch sizes result in faster individual updates, but more updates to convergence due to additional noise in the training process. Large minibatch sizes result in slower updates, but fewer updates to converge due to more accurate estimates of the error gradient. Minibatch sizes are often tuned to an aspect of the computational architecture on which the machine learning algorithm is being executed.

### SUMMARY

A first aspect of the disclosure provides a system for allocating data center resources, including: a machine learning process; a machine learning data set; a processing system including a plurality P of elements for training the machine learning process using the machine learning data set, wherein the machine learning data set is split into a plurality of batches with a batch size M; and a resource manager for minimizing a training time T=T(M,P) of the machine learning process over M for each value of P.

A second aspect of the disclosure provides an optimization system, including: a machine learning process; a machine learning data set; a processing system for training the machine learning process using the machine learning data set, wherein the machine learning data set is split into a plurality of batches with a batch size M; and a resource manager for determining a number P of parallel processing elements in the processing system such that a training time T=T(M,P) of the machine learning process is minimized for the batch size M and a cost constraint is met.

A third aspect of the disclosure provides an optimization method, including: training a machine learning process on a processing system using a machine learning data set, wherein the machine learning data set is split into a plurality of batches with a batch size M; and optimizing the processing system by: minimizing, using a plurality P of parallel processing elements in the processing system, a training time T=T(M,P) of the machine learning process over the batch size M for each value of P; or determining a number P of parallel processing elements in the processing system, such that a training time T=T(M,P) of the machine learning process is minimized for the batch size M.

Other aspects of the invention provide methods, systems, program products, and methods of using and generating each, which include and/or implement some or all of the actions described herein. The illustrative aspects of the invention are designed to solve one or more of the problems herein described and/or one or more other problems not discussed.

### BRIEF DESCRIPTION OF THE DRAWINGS

These and other features of the disclosure will be more readily understood from the following detailed description taken in conjunction with the accompanying drawings that depict various aspects of the invention.

FIG. 1 depicts a table of training experiments performed to support the equation N_{update}=N_{∞}+α/M according to embodiments.

FIG. 2 depicts a plurality of graphs showing N_{Update} as a function of M for a variety of SGD learning problems for a variety of conditions according to embodiments.

FIG. 3 depicts a plurality of graphs showing Nₐ, and a with various E for the CIFAR10 dataset for a constant learning rate according to embodiments.

FIG. 4 depicts a graph showing N_{∞} and α versus ∈ with both N_{∞} and a exhibiting a 1/ϵ relationship according to embodiments.

FIG. 5 depicts a graph showing the relationship between the average time to compute an SGD update versus minibatch size.

FIG. 6 depicts a plurality of parallel elements in a data center.

FIGS. 7 and 8 depict a data center with optimized scaling according to embodiments.

FIG. 9 depicts an illustrative process for determining M_{Opt}.

FIG. 10 depicts a processing system for implementing one or more embodiments or aspects thereof disclosed herein.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

The present invention relates generally to machine learning, and more particularly, to a method, system, and computer program product for optimizing parallel machine learning system design and performance using minibatch.

Aspects of the disclosure are directed to the idea that understanding the average algorithmic behavior of learning, decoupled from hardware concerns, can lead to deep insight that can be used to optimize parallel system performance and guide algorithmic development. To optimize the design of parallelized machine learning systems, the relationship between Stochastic Gradient Descent (SGD) learning time and node-level parallelism is explored. It has been found that a robust inverse relationship exists between minibatch size and the average number of SGD updates required to converge to a specified error threshold. Using this inverse relationship, an optimal data-parallel scaling method can be defined that outperforms both strong scaling and weak scaling. Advantageously, these results can be used to identify quantifiable implications for both hardware and algorithmic aspects of machine learning system design by providing specific guidance: (1) to hardware designers on how to best allocate limited system resources for optimal SGD convergence time (e.g., what is the optimal break even point); and (2) to learning algorithm designers on which global algorithmic parameters drive optimal SGD convergence time. In addition, these findings explain why time to compute an epoch, or any fixed number of updates, can be a misleading measure of system performance, and should be replaced with total time to converge.

The ultimate success of SGD machine learning for truly large, real-world learning problems depends on the ability to efficiently explore a vast space of algorithmic and model topology choices to build useful systems. The assessment of each choice in turn can require optimization in billion-dimensional parameter spaces. Thus, designing efficient hardware to run these learning problems is important.

As a result, significant research effort has been focused on accelerating minibatch SGD, primarily focused on faster hardware, node-level parallelization, and improved algorithms and system designs for efficient communication (e.g., parameters servers, efficient passing of update vectors, etc.) To assess the impact of these acceleration methods, published research typically evaluates parallel improvements based on the time to complete an epoch for a fixed minibatch size, what is commonly known as “weak” scaling.

According to aspects of the disclosure, it has been found that focusing on weak scaling can lead to suboptimal training times because it neglects the dependence of convergence time on the size of the minibatch used. The correct approach is to measure the time to convergence. The implications of this observation are explored herein and specific guidance on how to design optimal node-level parallelism for data-parallel SGD learning is provided.

Decomposing SGC Convergence Performance.

Given a learning problem represented by a data set, an SGD learning algorithm, and a learning model topology, the learning time, T, can be defined to be the average total time required for SGD to converge to a solution. Here, averaging is over all possible sources of noise in the process, including random initializations of the model, noise in SGD updates, noise in the system hardware, etc. Focusing on the average learning behavior allows fundamental properties of the learning process to be identified. In particular, the learning time can be written as:

T=N_{Update}·T_{Update} (EQN. 1)

where N_{Update} is the average number of updates required to converge, and T_{Update} is the average time to compute and communicate one update. This formulation decomposes the learning time T into an algorithm-dependent component (N_{Update}) and a hardware-dependent component (T_{Update}). It should be noted that N_{Update} is a measure of the difficulty of the learning problem, while T_{Update} is a measure of how hard it is to compute an update. Further, as will be presented in greater detail below, both N_{Update} and T_{Update} are functions of the minibatch size, M. In particular, N_{Update}(M) and T_{Update}(M,P) where P is the number of parallel elements used, (P≥1). In general, T_{Update} is proportional to the minibatch size M, while N_{Update} is inversely proportional to the minibatch size M. To this extent, a decrease in T_{Update} is associated with a corresponding increase in N_{Update}, and vice versa. The P elements are interconnected in a known manner via a communication fabric.

N_{Update} is independent of how fast the SGD updates are calculated, and is independent of both the choice of hardware and the choice of software implementations. N_{Update} depends only on the data, the learning algorithm used, and the learning model topology. On the other hand, T_{Update} depends on the choice of computational hardware, and the amount and type of computation required for a single update, e.g., the amount of data used to calculate each update, the model topology, the software implementation of the learning algorithm, and the time needed to communicate SGD updates between the parallel elements of the system. Thus, N_{Update} is independent of all hardware considerations and, for fixed algorithm and model topology, T_{Update} depends only on hardware choices. By decomposing the learning time T in this manner, the tasks of understanding how hardware and algorithmic choices impact the learning time T are decoupled and can be examined in isolation.

Modeling Average Convergence Time (Learning Time), T

In order to analyze SGD scaling, reliable models are needed of N_{Update} and T_{Update} as functions of the number of parallel elements used, P, and the minibatch size M. Using the models presented below, an optimal minibatch size, M_{Opt}, for T=T(M,P) can be derived. The optimal minibatch size M_{Opt} can be used in a wide variety of ways including, for example, optimizing hardware design for SGD and optimizing data center resource allocation.

In this disclosure, an element is generically considered a compute element from a suitable level of parallelism, e.g., a server, a CPU, a CPU core, a GPU, etc. In certain embodiments, an element can be considered a node. In practice, the software implementation, communication patters, and ultimately the efficiency will depend on the level of parallelism selected. However, the analysis below remains largely the same.

Modeling N_{Update}(M)

Since N_{Update} is independent of the hardware, it is independent of the number of compute elements used, and therefore depends only on the minibatch size M. Even with this simplification, measuring N_{Update} is generally impractical due to the computational expensive of running SGD to convergence for all values of M. However, it has been found that a robust empirical inverse relationship exists between N_{Update} and M, given by:

$${N}_{Update} = {N}_{∞} + \frac{α}{M} \qquad ( EQN . 2 )$$

where N_{∞} and α are empirical parameters depending on the data, model topology, and learning algorithm used. From EQN. 2, it can be seen that N_{Update} decreases as the minibatch size M increases, and N_{Update} increases as the minibatch size decreases. Experimental results supporting the inverse relationship shown in EQN. 2 are presented in greater detail below.

The inverse relationship in EQN. 2 shows that even if exact gradients are computed, i.e., even when M equals all of the data in a given data set, gradient descent still requires a non-zero number of steps to converge. For parallelization of SGD algorithms, this implies that there are diminishing returns from increased parallelism. Furthermore, according to the Central Limit Theorem, the variance of the SGD gradient is inversely proportional to M, for large M. Thus, N_{Update} increases approximately linearly with the SGD gradient variance, and α can be thought of the system's sensitivity to noise in the gradient.

Empirical Results

It have observed that, to a reasonable approximation, the relationship

$${N}_{Update} = {N}_{∞} + \frac{α}{M}$$

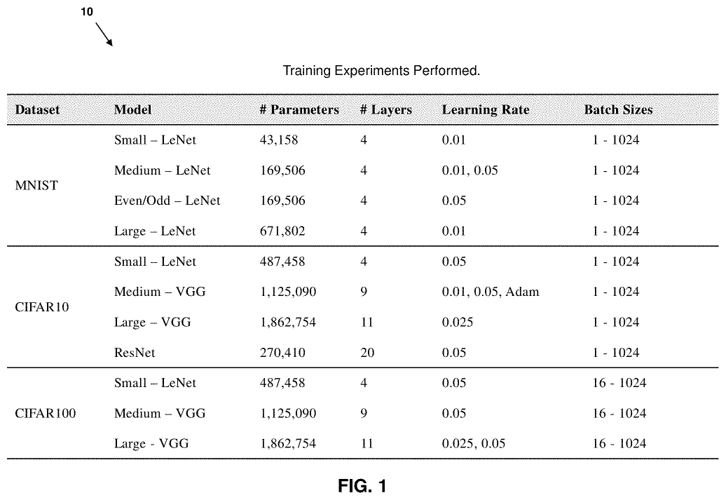

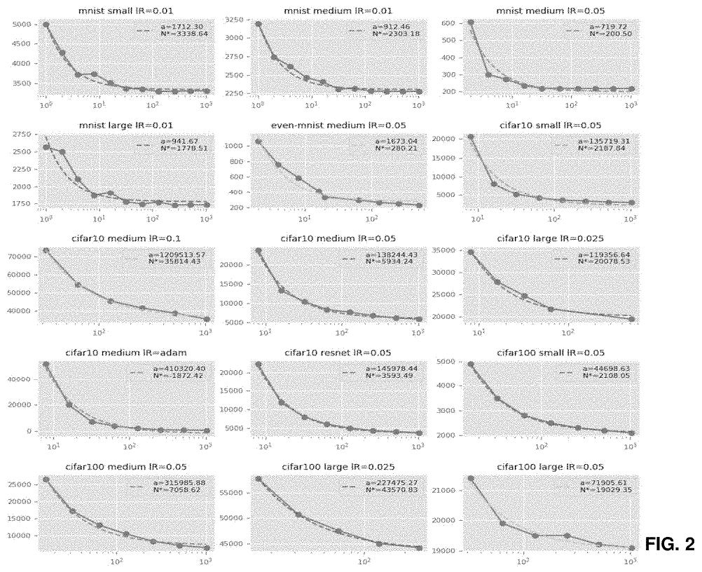

persists over a broad range of M, and a variety of machine learning dimensions, including the choice of data set, model topology, number of classes, convergence threshold, and learning rate. An example methodology used to support this equation and the results obtained are described below with regard to FIGS. 1 and 2.

To ensure the robustness of the data, a range of experiments over batch sizes from 1 to 1024 were conducted on benchmark image classification datasets. Experiments covered a variety of common model architectures such as LeNet, VGG, and ResNet, run on the MNIST, CIFAR10, and CIFAR100 data sets. The models were trained for a fixed number of updates with a slowly decaying learning rate. Light regularization was used with a decay constant of 10⁻⁴ on the L₂ norm of the weights. For each model architecture, the size in terms of width (i.e., parameters per layer) and depth (i.e., number of layers) were varied to measure the training behavior across model topologies. In addition, the same model was used across all three datasets (LeNet). Training was performed using the Torch library on a single K80 GPU. FIG. 1 summarizes the various experiments that were performed. Training and crossvalidation losses were recorded after each update for MNIST and after every 100 updates for CIFAR10 and CIFAR100, using two distinct randomly selected sets of 20% of the available data. The recorded results were examined to find the N_{Update} value that first achieves the desired training loss level, E. Note that this approach is equivalent to a stopping criterion with no patience. This was chosen because a model of the convergence rate as a function of was being developed.

Each MNIST experiment was averaged over ten runs with different random initializations to get a clean estimate of N_{Update} as a function of M. Averaging was not used with the other experiments, and as the results show, was not needed.

The results of the experiments depicted in FIG. 2 show a robust inverse relationship between N_{Update} and M measured across the datasets, models, and learning rates for each case that was considered. The fit lines match the observed data closely and N_{∞} and α were estimated. Because of the large number of possible combinations of experiments performed, only a representative subset of the graphs have been shown in FIG. 2 to illustrate the behavior that was observed in all experiments. This empirical behavior also exists for crossvalidation error, varying ∈, changing the number of output classes, etc.

FIG. 2 depicts N_{Update} as a function of M for a variety of SGD learning problems for a variety of conditions. The plots generally show the inverse relationship between N_{Update} and M in accordance with EQN. 2. The results depicted in FIG. 2 also show that large learning rates (shown as “IR” in the graphs) are associated with small N_{∞}.

Estimating N_{∞} and α

In order to exploit the inverse relationship of EQN. 2 for efficient system design, α and N_{∞} need to be estimated from an empirical N_{Update} curve in a computationally efficient way. This can be achieved, for example, by evaluating N_{Update} at two values of M and averaging as needed to remove noise from random initialization, SGD, etc. If the values of M are chosen strategically, the overhead of measuring α and N_{∞} can be reduced. In practice, as a learning model is explored, many experiments are run, allowing the cost of estimating α and N_{∞} to be amortized. Of course, when significant changes are made to the learning task (e.g., major topology change, learning rate change, target loss change, etc.) α and N_{∞} might need to be re-estimated.

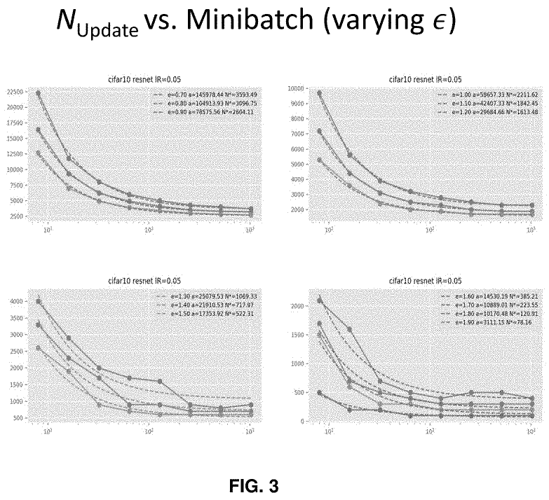

The theoretical analysis presented below supporting EQN. 2 suggests another path forward: that N_{∞} behaves like a constant+1/ϵ. To this extent, α and N_{∞} were fit for various values of the training loss, ϵ. From the corresponding plots shown in FIG. 3, it can be seen that the fits are very good for small ϵ, but grow noisier as E grows.

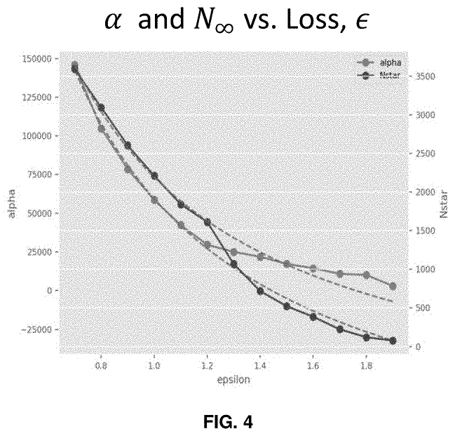

α and N_{∞} were then plotted versus ϵ as shown in FIG. 4. As can be seen, both α and N_{∞} exhibited a 1/ϵ relationship for small ϵ. Assuming that this relation holds in general, α and N_{∞} can be estimated once for a given E and the 1/ϵ relationship can be used to calculate updated α and N_{∞} for other values of ϵ.

A novel theoretical analysis of minibatch SGD convergence that supports EQN. 2 (reproduced below) is now described.

$${N}_{Update} = {N}_{∞} + \frac{α}{M} \qquad ( EQN . 2 )$$

Derivation of Minibatch-Based SGD Convergence Bound

Define the SGD update step as

x^{k+1}=x^{k}−η(∇f(x^{k})+ξ^{k}),

where f is the function to be optimized, x^{k} is a vector of neural net weights, ξ is a zero-mean noise term with variance ϕ², k represents the k^{th} step of the SGD algorithm, and η is the SGD step size. It is assumed that ∇T is Lipschitz continuous, i.e., that

f(x)≤f(y)+∇f(y)·(x−y)+L/2|x−y|²

for some constant L. When this inequality is applied to the SGD update relation, then

f(x^{k+1})≤f(x^{k})+∇f(x^{k})·(x^{k+1}−x^{k})+L/2|x^{k+1}−x^{k}|².

Averaging both sides over the noise, using the fact the E[ξ]=0, gives

$$E [ f ( {x}^{k + 1} ) ] \leq E [ f ( {x}^{k} ) - η ( 1 - \frac{η L}{2} ) {\vert ∇ f ( {x}^{k} ) \vert}^{2} + {η}^{2} \frac{L}{2} {\vert {ξ}^{k} \vert}^{2} ] .$$

Using Δₖ to denote the residual at the k^{th} step:

Δₖ≡f(x^{k})−f(x*),

where x* is a global minimum of f. Using the residual, the above inequality becomes

$${Δ}_{k + 1} \leq {Δ}_{k} - η ( 1 - \frac{η L}{2} ) {\vert ∇ f ( {x}^{k} ) \vert}^{2} + {η}^{2} \frac{L}{2} {φ}^{2} .$$

The convexity assumption

f(x^{k})−f(x*)≤∇f(x^{k})·(x^{k}−x*)≤|∇f(x^{k})|·|x^{k}−x*|

implies

$$\frac{{Δ}_{k}}{\vert {x}^{0} - {x}^{*} \vert} \leq \frac{{Δ}_{k}}{\vert {x}^{k} - {x}^{*} \vert} \leq \vert ∇ f ( {x}^{k} ) \vert .$$

Choosing the learning rate η such that

$$( 1 - \frac{η L}{2} ) > 0 ,$$

results in

Δₖ₊₁≤Δₖ−λΔₖ²+λσ²,

where

$$λ ≡ η ( 1 - \frac{η L}{2} ) \frac{1}{{( {x}^{0} - {x}^{*} )}^{2}} and {σ}^{2} ≡ \frac{{η}^{2} L}{2 λ} {φ}^{2} .$$

Rearranging this inequality as

(Δₖ₊₁−σ)≤(Δₖ−σ)(1−λ(Δₖ+σ)),

and observing that Δₖ cannot be smaller than a because of constant learning rate and additive noise, implies

1−λ(Δₖ+σ)≥0.

By taking the inverse and using the fact that

$$\frac{1}{1 - x} \geq 1 + x , x \leq 1 ,$$

then

$$\frac{1}{{Δ}_{k + 1} - σ} \geq \frac{1}{{Δ}_{k} - σ} ( 1 + λ ( {Δ}_{k} + σ ) ) = \frac{1 + 2 λσ}{{Δ}_{k} - σ} + η .$$

Then, telescoping this recurrence inequality results in

$$\frac{1}{{Δ}_{k + 1} - σ} + \frac{1}{2 σ} \geq {( 1 + 2 λσ )}^{k + 1} ( \frac{1}{{Δ}_{0} - σ} + \frac{1}{2 σ} ) .$$

Finally, solving for Δₖ, gives

$${Δ}_{k} \leq \frac{1}{{( 1 + 2 λσ )}^{k} ( \frac{1}{{Δ}_{0} - σ} + \frac{1}{2 σ} ) - \frac{1}{2 σ}} + σ , \qquad ( EQN . 3 )$$

and the number of updates to reach Δₖ≤∈ is given by

$${N}_{Update} \geq \frac{log [ \frac{∈ + σ}{∈ - σ} ] + log [ \frac{{Δ}_{0} - σ}{{Δ}_{0} + σ} ]}{log [ 1 + 2 λσ ]} \approx \frac{1}{ λ} ( \frac{1}{∈} - \frac{1}{{Δ}_{0}} ) ( 1 + \frac{{σ}^{2}}{3} ( \frac{1}{{∈}^{2}} + \frac{1}{{Δ}_{0}^{2}} + \frac{1}{∈ {Δ}_{0}} ) )$$

for small σ. Using the Central Limit Theorem, it can be observed that

$${σ}^{2} \approx \frac{θ}{M}$$

and therefore

$${N}_{Update} \geq \frac{1}{λ} ( \frac{1}{ϵ} - \frac{1}{{Δ}_{0}} ) ( 1 + \frac{θ}{M} ( \frac{1}{{ϵ}^{2}} + \frac{1}{{Δ}_{0}^{2}} + \frac{1}{ϵ {Δ}_{0}} ) ) . \qquad ( EQN . 4 )$$

The fact that the bound in EQN. 4 exhibits the same inverse relationship as

$${N}_{Update} = {N}_{∞ } + \frac{α}{M}$$

reinforces the robustness of the empirical finding.

Comparison to Convergence Rate of Gradient Descent Method

Note that EQN. 3 appears to suggest exponential convergence because of the power of k term in the denominator. A closer analysis shows that this is not correct. Specifically, in the limit σ→0, the well-known 1/k convergence rate of gradient descent is recovered:

$${Δ}_{k} \leq {lim}_{σ \to 0} \frac{2 σ}{( 1 + 2 λ σ k + … ) ( \frac{2 σ}{{Δ}_{0} - σ} + 1 ) - 1} + σ = \frac{1}{\frac{1}{{Δ}_{0}} + λ k} .$$

Also, one can show that the bound is always bigger than the limit:

$$\frac{1}{{( 1 + 2 λ σ )}^{k} ( \frac{1}{{Δ}_{0} - σ} + \frac{1}{2 σ} ) - \frac{1}{2 σ}} + σ \geq \frac{1}{\frac{1}{{Δ}_{0}} + λ k} ,$$

and thus, the exponential term cannot converge faster than 1/k. The proof follows from expanding (1+2λσ)^{k} to the first order and simplifying, and using Δ₀≥σ.

Modeling T_{Update}(M,P)

T_{Update} can be determined by running several iterations of the SGD algorithm on a chosen number of compute elements and measuring the average time to perform an update for a specified minibatch size M. This process is possible because T_{Update}(M,P) is approximately constant throughout SGD learning; so it need only be measured once for each (M,P) pair of interest. This approach can be used to compare differences between specific types of hardware, software implementations, etc. The measured T_{Update} can then be used to fit an analytical model to be used in conjunction with N_{Update} to model T(M,P).

In order to analyze the generic behavior, T_{Update}(M,P) can be modelled as:

T_{update}(M,P)=Γ(M)+Δ(P), (EQN.5)

where Γ(M) is the average time to compute an SGD update using M samples, and Δ(P) is the average time to communicate gradient updates between P elements. If some of the communication time can occur during computation, then Δ(P) represents the portion of communication time that is not overlapping with computation. Since computation and communication are generally handled by separate hardware, it is a good approximation to assume that they can be decoupled in this way.

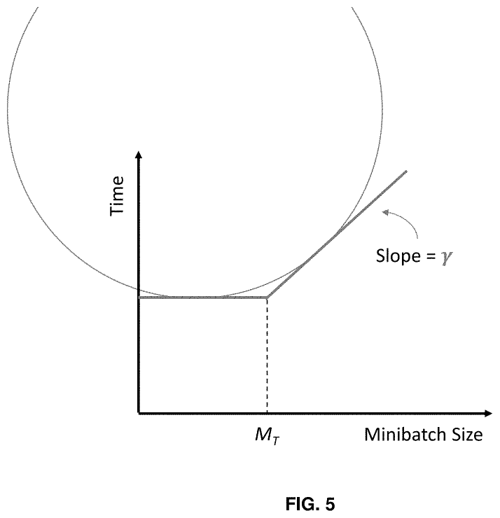

Since Γ(M) typically performs the same amount of computation for each data sample, one might expect a linear relationship, Γ(M)=γ·M, for some constant, γ. Here, the generally insignificant time required to sum over M data samples on an element is neglected. However, in practice, hardware and software implementation inefficiencies lead to a point where reducing M does not reduce compute time linearly. A graph illustrating this relationship is depicted in FIG. 5. This effect can be approximated using

Γ(M)=γ max(M,M_{T}),

where M_{T} is the threshold at which the linear relationship begins. For example, M_{T} could be the number of cores per CPU, if each sample is processed by a different core; or M_{T} could be 1 if a single core processes all samples. Ideally, efficient SGD hardware systems should achieve low γ and M_{T}. In practice, however, an empirical measurement of this relationship provides more fidelity; but for the purposes of this disclosure, this model is sufficient.

The communication time, Δ(P), vanishes when P=1. When P>1, Δ(P) depends on various hardware and software implementation factors. For optimal performance, it can be assumed that communication is performed using the Message Passing Interface (MPI) function MPIAIIReduce( ) on a high powered compute cluster. Such systems provide a powerful network switch and an efficient MPIAIIReduce( ) implementation that delivers near perfect scaling of MPIAllreduce( ) bandwidth, and so Δ(P)=δ, for some constant δ, which is very close to the bandwidth of each node. For comparison purposes, a plain synchronous parameter server has Δ(P)=δ·P.

An efficient SGD system will attempt to overlap computation and communication. In backward propagation, gradient updates for all but the input layer can be transferred during the calculation of updates for subsequent layers. In such systems, the communication time Δ(P) is understood to mean the portion that does not overlap with computation.

Combining the relationships for N_{Update} (EQN. 2) and T_{Update} (EQN. 5) yields the following general approximation to the total convergence time for SGD running on P parallel elements:

$$T ( M , P ) = ( {N}_{∞} + \frac{α}{M} ) [ γ max ( \frac{M}{P} , {M}_{T} ) + δ ] . \qquad ( EQN . 6 )$$

It should be noted that this equation relies on certain assumptions about the hardware that might not be true in general, e.g., that δ is a constant. These assumptions have been chosen to simplify the analysis; but in practice, one can easily measure the exact form of T_{Update} and still follow through with the analysis below.

Given this approximation for T(M,P), system performance can be analyzed in numerous ways. As an example, as disclosed below, the data-parallel scaling behavior of SGD-based machine learning may be analyzed. One additional consideration arises regarding crossvalidation (CV) since SGD training is rarely performed without some form of CV stopping criterion. The effect of CV in our model may be accommodated, for example, by including a CV term, such that

Γ(M)=γN max(M,M_{T})+γ_{CV} max(M_{CV},M_{T})

where N is the number of SGD updates per CV calculation and M_{CV} is the number of CV samples to calculate. For simplicity, CV may be ignored. Additionally, the calculation of a CV subset adds virtually no communication, since the parallel elements computing the CV estimate need only communicate a single number when they are done.

Data Parallel Scaling of Parallel SGD

Scaling measures the total time to solution as a function of the number of computer elements. Traditionally there are two scaling schemes, strong scaling and weak scaling, which are described in greater detail below. It should be noted that neither of these scaling techniques is ideal for SGD-based machine learning. To this extent, a new scaling, optimal scaling, is introduced and compared to strong scaling and weak scaling.

The analysis assumes data parallelism, i.e., that the number of data samples assigned to each element is an integer. Data parallelism leads to node-level load imbalance (and corresponding inefficiency) when the minibatch size is not a multiple of the number of elements P. For convenience, the analysis below ignores these effects and thus presents a slightly more optimistic analysis. The alternatives are to take a model parallel approach in which a single data sample is split over multiple elements, or a hybrid approach in which both data and model parallelism are used. However, model splitting requires additional communication and incurs additional computational inefficiencies that generally lead to less efficient performance than pure data parallelism.

Strong Scaling

Strong scaling occurs when the problem size remains fixed. This means that the amount of compute per element decreases as P increases. For training tasks, this implies that M is fixed, i.e., M=M_{Strong}. In this case, N_{Update} does not change, so the training time improves only when T_{Update} decreases. Thus, strong scaling hits a minimum when P>M_{Strong}/M_{T}.

Weak Scaling

Weak scaling occurs when the problem size grows proportionately with the number of elements P. This implies that for training tasks, M grows linearly with P (i.e., M=mP) and therefore N_{Update} decreases as P increases, while T_{Update} remains constant, for constant m. Weak scaling can be optimized by selecting m appropriately, which leads to the optimal scaling described below.

Optimal Scaling

The constant M of strong scaling and the linear M of weak scaling prevent these methods from achieving optimal performance, and are therefore inappropriate for SGD-based machine learning. According to the disclosure, an alternative approach to scaling is proposed that, unlike strong and weak scaling, minimizes T(M,P) over M for each value of P. Such an optimal scaling approach allows better performance to be achieved compared to either strong or weak scaling.

M can be optimized by considering two cases:

For M>M_{T}P, the optimal M is determined by minimizing

$$T ( M , P ) = ( {N}_{∞} + \frac{α}{M} ) ( \frac{γ M}{P} + δ ) .$$

### For M≤M_{T}P,

T(M,P)≥T(M_{T}P,P)

and therefore, the optimal M is given by m_{T}P. Thus, in general, the optimum M is

$${M}_{Opt} ( P ) = max ( {M}_{T} P , \sqrt{\frac{α}{{N}_{∞}} \frac{δ}{γ} P} ) , \qquad ( EQN . 7 )$$

and the minimum time to convergence is given by

$$T ( P ) = \{ \begin{matrix}{( \sqrt{δ {N}_{∞}} + \sqrt{\frac{α γ}{P}} )}^{2} , & P < \frac{α δ}{γ {M}_{T}^{2} {N}_{∞}} \\ ( {N}_{∞} + \frac{α}{{M}_{T} P} ) ( δ + γ {M}_{T} ) , & otherwise\end{matrix} . \qquad ( EQN . 8 )$$

Note that for large P (i.e., the second condition above), optimal scaling is identical to weak scaling if we choose M=M_{T}. In this way, optimal scaling naturally defines the per element minibatch size for weak scaling.

It should be noted that an optimum P_{Opt} for a given minibatch size M can also be determined based on the above equations. P_{Opt} may be used, for example, by a data center to optimize the allocation of parallel elements 10 to different machine learning problems.

EQN. 8 captures optimal scaling behavior as a function of the number of elements P. Advantageously, from EQN. 8, it is now possible to quantitatively observe how the total time to convergence (learning time) T is affected by a variation in the number of elements P. For example, from EQN. 8, one can observe the potential benefit (if any) that an increase of the number of elements from P to P+1 may have on the time to convergence T. Any such benefit can be weighed against the cost of increasing the number of elements by 1 to determine if the increase in P is worth the increased effort and cost associated with adding another processing node.

System Design: Cost Benefit Analysis

Ultimately, the choice of an optimal system design point depends on the cost effectiveness of the various trade-offs. Based on a few system parameters, one can use T(P,γ,δ) with the relative cost of hardware (elements, communication network, etc.) and the value of the time savings to decide on the most cost-effective number of elements to use and/or allocate. This principle can be used to optimize machine learning data center resource allocation by assigning elements amongst multiple different learning problems so as to minimize the total learning time, or other criterion. This principle may also be used by designers of learning systems to optimize the number of elements needed to converge a system.

One technique for optimal data center resource allocation in a machine learning data center can be expressed as follows:

Given N jobs to run in a data center having P total elements, then

$${min}_{\{ {P}_{i} \}} ( {\sum }_{i = 1}^{N} {a}_{i} \cdot {T}_{Opt} ( {P}_{i} , {α}_{i} , {N}_{i} , {γ}_{i} , {δ}_{i} ) ) , \qquad ( EQN . 9 )$$

where aᵢ (aᵢ≥0) is job prioritization and τₗPᵢ=P.

In the case where there is a hardware cost constraint (e.g., for SGD), then the cost constraint may be given by:

Cost of Compute+Cost of Bandwidth=C_{C}(P,γ)+C_{BW}(δ)=constant.

To this extent, hardware design optimization includes finding the mix of compute and bandwidth that satisfies:

$$\frac{Δ T ( {M}_{Opt} ( P ) , P , γ}{Δ C ( P , γ )} = \frac{Δ T ( {M}_{Opt} ( P ) , P , γ )}{Δ C ( δ )} \qquad ( EQN . 10 )$$

In other words, performance gain per unit price should be balanced at the optimal design point. Other and/or additional constraints could be included, in general involving some form of nonlinear programming to optimize.

According to the disclosure, there is provided a methodology for establishing a quantitative model of time to train, which can be used to optimize system performance and guide algorithmic development. The model captures an elemental decomposition of training time and a robust empirical relationship between number of updates and minibatch size.

Training time T has been shown to be decomposable as follows:

T=N_{Update}·T_{Update}

where N_{Update} is dependent upon minibatch size M, model complexity, data complexity, and SGD algorithm efficiency, while T_{Update} captures effects from the hardware system used for training, such as communication time, software implementation efficiency and hardware performance.

A novel and robust empirical relationship has been disclosed herein between data-parallel scaling behavior and SGD training time. This relationship has been used to derive optimal scaling for SGD machine learning, to define optimal system design, and to provide guidance on future algorithmic design. Once the functional forms of N_{Update} and T_{Update} are known, the scaling behavior can be predicted by minimizing training time over minibatch size M, for a given level of parallelism P. In practice, T_{Update} can be measured easily; but determining N_{Update} requires, in principle, SGD iteration until convergence with many different minibatch sizes, which in general is simply impractical.

As detailed above, there exists a robust empirical model of N_{Update},

$${N}_{Update} = {N}_{∞} + \frac{α}{M} ,$$

which removes this problem. For example, one possibility is to determine α and N_{∞} in the early stage of training and then use the fit to choose M.

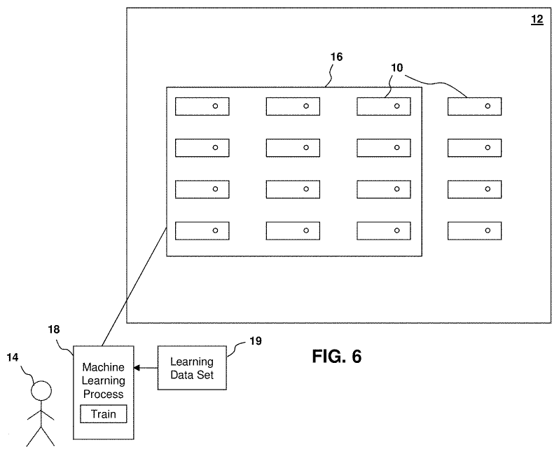

FIG. 6 depicts a plurality of parallel elements 10 in a data center 12. In this example, the data center 12 includes sixteen parallel elements 10. In general, a data center may include any number of parallel elements. For example, some of the largest extant data centers include hundreds of thousand of parallel elements.

In FIG. 6, an entity 14 is initially utilizing a set 16 of twelve (P=12) parallel elements 10 to train a machine learning process 18 (e.g., minibatch SGD). A machine learning data set 19 is used in the training of the machine learning process 18 (e.g., to determine α and N_{∞}). It is assumed that the choice of P=12 and the minibatch size M=M₁ were made in a manner known in the art.

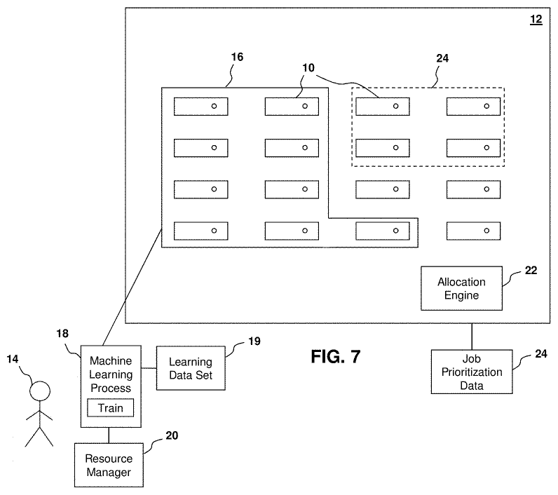

In FIG. 7, a resource manager 20 is provided to optimize the training time T for the machine learning process 18 by applying the optimization methodology disclosed herein (e.g., to obtain an optimal M and/or system configuration and/or resource allocation). As an example, it may be determined (e.g., by the entity 14 or the data center 12) that the training time T for the machine learning process 18 may be reduced (optimized) by using a smaller number of parallel elements 10 (e.g., P=9) and a different minibatch size (e.g., M=M₂, where M₁≠M₂) in accordance with EQS. 7 and 8. This reduces the cost to the entity 14 and accelerates the training time of the machine learning process 18. In addition, an allocation engine 22 of the data center 12 can now allocate a set 24 containing some or all of the non-allocated parallel elements 10 to an entity 14′, increasing revenue for the data center 12. Further, as shown in FIG. 7, the allocation engine 22 of the data center 12 may prioritize jobs to be run on the parallel elements 10 based on, for example, the relationship set forth in EQN. 10. In this case, job prioritization data 24 and data from one or more resource managers s 20 may be provided to the allocation engine 22 of the data center 12.

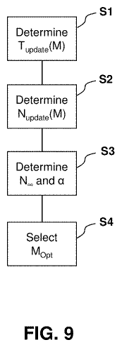

An illustrative process for determining M_{Opt} is depicted in FIG. 9. At S1, T_{Update}(M) is determined for a plurality of updates for a range of M. At S2, for a plurality of values of M, N_{Update}(M) is determined by running to convergence. At S3, N_{∞} and α are determine using N_{Update}(M). At S4, M_{Opt} is selected using T_{Update} (M) and N_{Update}(M, N_{∞}, α).

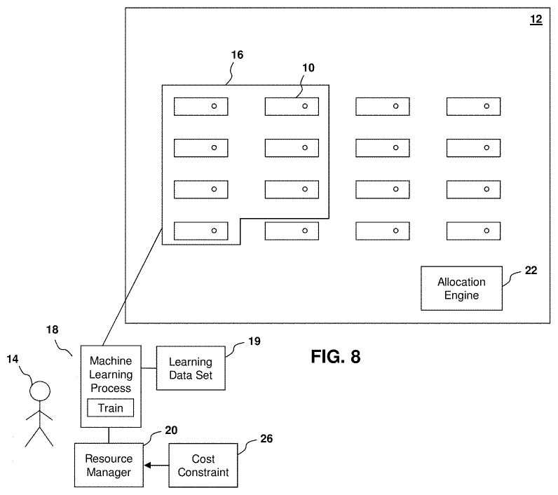

In FIG. 8, a resource manager 20 is again provided to optimize the training time T for the machine learning process 18 by applying the optimization methodology disclosed herein. In addition, a cost constraint 26 for the entity 14 may be provided to the resource manager 20. Based in part on the cost constraint 26, a design point (e.g., P, T, M) may be determined in accordance with EQS. 7, 8, and 10 to optimize performance gain per unit price for the entity 14. Comparing FIGS. 8 and 9, it can be seen that the addition of the cost constraint 26 may result in a change in the size of the set 16 of parallel elements 10 allocated to the machine learning process 18 (e.g. set 16 has decreased from 8 elements to 7 elements).

Additional Considerations

Data Dependence

It has been found that as the learning problem grows in complexity, its sensitivity to noise grows (i.e., α grows). Thus, the onset of the N_{∞} “floor” is pushed to larger minibatch values. This suggests that the benefit of parallelism may grow more complex learning challenges are explored. However, this benefit must be balanced by any related increase in N_{∞}, which will in general also grow with complexity.

Beyond SGD

It should be noted that the methodology presented herein is not limited to SGD. It is applicable to any algorithm that has a calculation phase followed by a model update phase. In general, the methodology described herein provides a novel way of comparing the parallelization effectiveness of algorithms.

Hardware Design

As should be apparent from disclosure, there is no one-size-fits-all for machine learning system design. Each learning problem, model, and algorithm will potentially have unique α and N_{∞} values and will benefit from different values of δ, γ and M_{T}². Of course, even if a data center has a fixed set of system parameters, one can still optimize the allocation of data center resources based on the methodology presented herein.

Improved Learning Algorithms

Data-parallel scaling can be improved through the development of algorithms with lower N_{∞}. Algorithms that make better use of the data to generate improved update estimates and thereby reduce N_{∞} (e.g., perhaps second order methods) are prime candidates. Of course, this reduction needs to be understood in the context of a tradeoff with a concomitant increase in T_{Update}.

Local Minima

Research has shown that increasing minibatch size generally has negative effects on generalization. Intuitively, the reduced gradient stochasticity of larger minibatches leads to increased risk of getting stuck in local minima. This problem is important to data-parallel scaling of SGD. Machine learning practitioners will have to deal with this effect if and as parallelization efficiency improves. Additional regularization might be required.

Throughput Parallelization

Aspects of the disclosure have focused on the challenges of parallel training. Once systems are trained, there should be no similar fundamental barriers to massively parallel operation of the trained networks on new data for classification, etc.

Enhance Machine Learning Libraries

Today's machine learning libraries do not provide convenient nor efficient methods for overlapping computation with communication. Developing algorithms and libraries that do so will have significant positive impact on scaling performance.

Various aspects of the disclosure may be provided as a system, method, and/or computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying various aspects of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the disclosure are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While it is understood that the program product of the present invention may be manually loaded directly in a computer system via a storage medium such as a CD, DVD, etc., the program product may also be automatically or semi-automatically deployed into a computer system by sending the program product to a central server or a group of central servers. The program product may then be downloaded into client computers that will execute the program product. Alternatively the program product may be sent directly to a client system via e-mail. The program product may then either be detached to a directory or loaded into a directory by a button on the e-mail that executes a program that detaches the program product into a directory. Another alternative is to send the program product directly to a directory on a client computer hard drive.

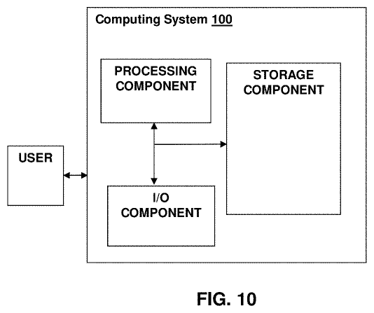

FIG. 10 depicts an illustrative processing system 100 for implementing various aspects of the present disclosure, according to embodiments. The processing system 100 may comprise any type of computing device and, and for example includes at least one processor, memory, an input/output (I/O) (e.g., one or more I/O interfaces and/or devices), and a communications pathway. In general, processor(s) execute program code, which is at least partially fixed in memory. While executing program code, processor(s) can process data, which can result in reading and/or writing transformed data from/to memory and/or I/O for further processing. The pathway provides a communications link between each of the components in processing system 100. I/O can comprise one or more human I/O devices, which enable a user to interact with processing system 100.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual skilled in the art are included within the scope of the invention as defined by the accompanying claims.

What is claimed is:

1. A system for allocating data center resources, comprising:
a machine learning process;
a machine learning data set;
a processing system including P parallel processing elements for training the machine learning process using the machine learning data set, wherein the machine learning data set is split into a plurality of batches with a batch size M; and
a resource manager for minimizing a training time T=T(M,P) of the machine learning process over the batch size M for each value of P.

2. The system of claim 1, wherein
T=N_{update}*T_{Update},
where N_{Update} is an average number of updates required for convergence of the machine learning process on the P parallel processing elements and T_{Update} is an average time to compute and communicate each update on the P parallel processing elements.

3. The system of claim 2, wherein the resource manager determines an optimal batch size M_{Opt} such that the training time T=T(M_{Opt},P) is minimized for:
each value of P; or
each value of P and based on a cost constraint.

4. The system of claim 2, wherein N_{Update} is independent of the time to compute and communicate each update on the P parallel processing elements.

5. The system of claim 2, wherein N_{Update} is given by:
$${N}_{Update} = {N}_{∞} + \frac{α}{M}$$
where N_{∞} and α are empirical parameters depending on the machine learning process, the machine learning data set, and the processing system.

6. The system of claim 3, further comprising an allocation system for allocating a subset of the P parallel processing elements to the machine learning process based on M_{Opt}.

7. The system of claim 2, wherein T_{Update} is determined by:
running several iterations of the machine learning process on a predetermined number of the parallel processing elements; and
measuring the average time to perform an update for a predetermined batch size M.

8. The system of claim 5, wherein M_{Opt} is determined by:
for a range of M, determine T_{update}(M) for a plurality of updates;
for a plurality of values of M, determine N_{Update}(M) by running to convergence;
determine N_{∞} and α using N_{Update}(M), and
select M_{Opt} using T_{Update}(M) and N_{Update}(M, N_{∞}, α).

9. An optimization system, comprising:
a machine learning process;
a machine learning data set;
a processing system for training the machine learning process using the machine learning data set, wherein the machine learning data set is split into a plurality of batches with a batch size M; and
a resource manager for determining a number P of parallel processing elements in the processing system such that a training time T=T(M,P) of the machine learning process is minimized for the batch size M and a cost constraint is met.

10. The optimization system of claim 9, further including a cost constraint, wherein the resource manager further determines P based on the cost constraint to optimize performance gain per unit price.

11. The optimization system of claim 9, wherein the resource manager further determines P based on a priority of the machine learning process.

12. The optimization system of claim 9, further including an allocation system for allocating the P parallel processing elements to the machine learning process.

13. The optimization system of claim 9, wherein
T=N_{Update}*T_{Update},
where N_{Update} is an average number of updates required for convergence of the machine learning process on the P parallel processing elements and T_{Update} is an average time to compute and communicate each update on the P parallel processing elements.

14. The optimization system of claim 13, wherein N_{Update} is independent of the time to compute and communicate each update on the P parallel processing elements.

15. The optimization system of claim 13, wherein N_{Update} is given by:
$${N}_{Update} = {N}_{∞} + \frac{α}{M}$$
where N_{∞} and α are empirical parameters depending on the machine learning process, the machine learning data set, and the processing system.

16. The optimization system of claim 13, wherein T_{Update} is determined by:
running several iterations of the machine learning process on the P parallel processing elements; and
measuring the average time to perform an update for a predetermined batch size M.

17. An optimization method, comprising:
training a machine learning process on a processing system using a machine learning data set, wherein the machine learning data set is split into a plurality of batches with a batch size M; and
optimizing the processing system by:
minimizing, using P parallel processing elements in the processing system, a training time T=T(M,P) of the machine learning process over the batch size M for each value of P; or
determining a number P of parallel processing elements in the processing system, such that a training time T=T(M,P) of the machine learning process is minimized for the batch size M.

18. The optimization method of claim 17, wherein
T=N_{Update}*T_{Update},
where N_{Update} is an average number of updates required for convergence of the machine learning process on the P parallel processing elements and T_{Update} is an average time to compute and communicate each update on the P parallel processing elements.

19. The optimization method of claim 17, wherein N_{Update} is given by:
$${N}_{Update} = {N}_{∞} + \frac{α}{M}$$
where N_{∞} and α are empirical parameters depending on the machine learning process, the machine learning data set, and the processing system.

20. The optimization method of claim 17, wherein T_{Update} is determined by:
running several iterations of the machine learning process on the P parallel processing elements; and
measuring the average time to perform an update for a predetermined batch size M.
